(19) United States
(12) Patent Application Publication
(10) Pub. No.: US 2025/0313007 A1
(43) Pub. Date: Oct. 9, 2025

(54) METHOD FOR CORRECTING SPEED OF CARRIAGE, AND PRINTER

(71) Applicant: Roland DG Corporation, Hamamatsu-shi (JP)

(72) Inventors: Kiyoshi FUJIMOTO, Hamamatsu-shi (JP); Kiyomasa IMAIZUMI, Hamamatsu-shi (JP); Hironari OKAMOTO, Hamamatsu-shi (JP); Yudai CHIDA, Hamamatsu-shi (JP)

(21) Appl. No.: 19/244,366

(22) Filed: Jun. 20, 2025

Related U.S. Application Data
(63) Continuation of application No. PCT/JP2023/045256, filed on Dec. 18, 2023.

(30) Foreign Application Priority Data
Dec. 23, 2022 (JP) 2022-206969

(51) Int. Cl. B41J 2/045; B41J 29/38

(52) U.S. Cl. CPC B41J 2/04503; B41J 29/38; B41J 2/04581

(57) ABSTRACT

A motor of a printer is capable of rotating at a rotation speed controlled to be constant based on a rotation position of a motor shaft measured by a motor encoder so as to move a carriage. A linear encoder measures positions of the carriage in a moving direction. Differences between each of rotation positions of the motor shaft based on the measurement by the motor encoder and a corresponding rotation position of the motor shaft based on the measurement by the linear encoder are calculated, for positions rotation during one or more rotation(s) of the motor shaft. A correction value to be added to the rotation positions of the motor shaft measured by the motor encoder is determined, based on the calculated differences, such that a change in the rotation speed of the motor shaft, during one rotation thereof, based on the measurement by the linear encoder, is decreased.

### CROSS REFERENCE TO RELATED APPLICATIONS

This application claims the benefit of priority to Japanese Patent Application No. 2022-206969 filed on Dec. 23, 2022 and is a Continuation Application of PCT Application No. PCT/JP2023/045256 filed on Dec. 18, 2023. The entire contents of each application are hereby incorporated herein by reference.

### BACKGROUND OF THE INVENTION

### 1. Field of the Invention

The present invention relates to methods for correcting speeds of carriages of printers, and printers.

### 2. Description of the Related Art

A printer to print an image on a recording medium while causing a carriage having a print head mounted thereon to move in a predetermined scanning direction is conventionally known. For example, Japanese Patent Application Publication No. 2002-361857 discloses an inkjet printer that includes an electric motor to cause an inkjet head to move and a linear scale, and reads the position, in a scanning direction, of the inkjet head from marks engraved in the linear scale to provide moving position data on the inkjet head. The inkjet printer disclosed in Japanese Patent Application Publication No. 2002-361857 is described as correcting a measured moving distance that is read from the linear scale by use of an actual moving distance of the inkjet head calculated from a rotation angle of the electric motor, in consideration that the linear scale expands or contracts in accordance with the weather conditions.

Many motors each include a motor shaft and a motor encoder measuring a rotation position of the motor shaft, and are each configured such that the rotation speed thereof is controlled based on the rotation position of the motor shaft measured by the motor encoder. As described in Japanese Patent Application Publication No. 2002-361857, the rotation position of the motor shaft measured by the motor encoder is assumed to be correct. However, the present inventors have noticed that the rotation speed of such a motor may occasionally be changed during one rotation of the motor shaft although the motor is controlled to rotate at a constant speed. According to the knowledge of the present inventors, this occurs because, for example, there is eccentricity between the motor shaft and the motor encoder. In the case where there is eccentricity between the motor shaft and the motor encoder, the motor encoder cannot measure the rotation position of the motor shaft correctly, and the rotation speed of the motor is controlled based on the incorrect rotation position of the motor shaft. As a result, the speed of the motor changes during one rotation of the motor shaft although the motor is controlled to rotate at a constant speed. In the case where the motor has characteristics of speed change, the speed of the carriage changes during one rotation of the motor shaft.

### SUMMARY OF THE INVENTION

Example embodiments of the present invention provide methods, for printers, for decreasing changes in carriage speeds caused by changes in rotation speeds during one rotation of the motor that causes the carriage to move.

A method according to an example embodiment of the present invention is a method for correcting a speed of a carriage in a printer including a print head, the carriage having the print head mounted thereon and moving in a predetermined scanning direction, and a motor to cause the carriage to move. The motor includes a motor shaft and a motor encoder to measure a rotation position of the motor shaft, and is capable of rotating at a rotation speed thereof controlled based on the rotation position of the motor shaft measured by the motor encoder. The method disclosed herein includes a preparation step, a moving step, a measurement step, a first calculation step, a second calculation step, a determination step, and a correction step. In the preparation step, a linear encoder to measure a position of the carriage in the scanning direction is prepared. In the moving step, the motor is rotated such that the rotation speed thereof based on the measurement performed by the motor encoder is constant, and the carriage is caused to move. In the measurement step, a plurality of the positions of the carriage in the scanning direction in the moving step are measured by use of the linear encoder. In the first calculation step, rotation positions of the motor shaft in the moving step are identified based on the measurement performed by the linear encoder. In the second calculation step, a difference between each of a plurality of the rotation positions of the motor shaft based on the measurement performed by the motor encoder and the corresponding rotation position of the motor shaft based on the measurement performed by the linear encoder is calculated for a plurality of rotation positions during one rotation or a plurality of rotations of the motor shaft. In the determination step, a correction value to be added to the rotation positions of the motor shaft measured by the motor encoder is determined based on the differences calculated in the second calculation step, such that a change in the rotation speed of the motor shaft, during one rotation thereof, based on the measurement performed by the linear encoder is decreased. In the correction step, the correction value is added to the rotation positions of the motor shaft measured by the motor encoder.

A printer according to an example embodiment of the present invention includes a print head, a carriage having the print head mounted thereon and movable in a predetermined scanning direction, a motor to cause the carriage to move, a linear encoder to measure a position of the carriage in the scanning direction. The motor includes a motor shaft and a motor encoder to measure a rotation position of the motor shaft, and is capable of rotating at a rotation speed thereof controlled based on the rotation position of the motor shaft measured by the motor encoder. The controller is configured or programmed to include a moving controller, a measurement controller, a first calculator, a second calculator, a correction value determinator, and a corrector. The moving controller is configured or programmed to rotate the motor such that the rotation speed thereof based on the measurement performed by the motor encoder is constant, and to cause the carriage to move. The measurement controller is configured or programmed to measure a plurality of the positions of the carriage in the scanning direction by the linear encoder while the carriage is moving under the control of the moving controller. The first calculator is configured or programmed to identify rotation positions of the motor shaft during the moving of the carriage, based on the measurement performed by the linear encoder. The second calculator is configured or programmed to calculate a difference between each of a plurality of the rotation positions of the motor shaft based on the measurement performed by the motor encoder and the corresponding rotation position of the motor shaft identified by the first calculator, for a plurality of rotation positions during one rotation or a plurality of rotations of the motor shaft. The correction value determinator is configured or programmed to determine a correction value to be added to the rotation positions of the motor shaft measured by the motor encoder, based on the differences calculated by the second calculator, such that a change in the rotation speed of the motor shaft, during one rotation thereof, based on the measurement performed by the linear encoder is decreased. The corrector adds the correction value to the rotation positions of the motor shaft measured by the motor encoder.

According to the above-described method, in the moving step and the measurement step, the carriage is actually caused to move and the motor encoder and the linear encoder are caused to perform the measurements. Thus, a correction value that is to be added to the rotation position of the motor shaft measured by the motor encoder, and that decreases the change in the rotation speed of the motor shaft, during one rotation thereof, based on the measurement performed by the linear encoder is obtained. The rotation speed of the motor shaft based on the measurement performed by the linear encoder represents the actual rotation speed of the motor shaft. Therefore, according to the above-described method, the change in the speed of the carriage caused by the change in the rotation speed of the motor, causing the carriage to move, during one rotation of the motor, is decreased. The above-described printer provides substantially the same function and effect.

The above and other elements, features, steps,

characteristics and advantages of the present invention will become more apparent from the following detailed description of the example embodiments with reference to the attached drawings.

### BRIEF DESCRIPTION OF THE DRAWINGS

FIG. 1 is a front view of a printer according to an example embodiment of the present invention.

FIG. 2A is a schematic view showing a configuration of a carriage motor.

FIG. 2B is a view schematically showing a portion, of the carriage motor, that is involved in rotation control.

FIG. 3 is a graph showing a shift in position detection for a motor shaft caused by eccentricity.

FIG. 4 is a flowchart showing a procedure for correcting a rotation speed of the carriage motor.

FIG. 5 is a block diagram showing the rotation control, on a carriage motor, including an eccentricity correction process.

FIG. 6 is a block diagram showing a procedure of the eccentricity correction process.

FIG. 7 is a graph showing a comparison of a pre-correction speed of the carriage and a post-correction speed of the carriage.

FIG. 8 is a flowchart showing a second calculation step in detail.

FIG. 9 is a graph showing the amount of eccentricity of the carriage motor.

FIG. 10 is a graph showing the amount of eccentricity after noise is removed.

FIG. 11 is a graph showing the phase difference and the gain of the line showing the amount of eccentricity after noise is removed.

FIG. 12 is a graph showing the amount of eccentricity, FIG. 12 showing another method for calculating a phase difference.

FIG. 13 is a graph showing the amount of eccentricity, FIG. 13 showing still another method for calculating the phase difference.

FIG. 14 is a block diagram of a printer according to another example embodiment of the present invention.

### DETAILED DESCRIPTION OF THE EXAMPLE EMBODIMENTS

Hereinafter, inkjet printers (hereinafter, referred to

simply as a “printer” or “printers”) according to example embodiments of the present invention will be described with reference to the drawings. The example embodiments described herein are not intended to specifically limit the present invention.

Elements and portions having the same functions bear the same reference signs, and overlapping descriptions will be omitted or simplified as appropriate.

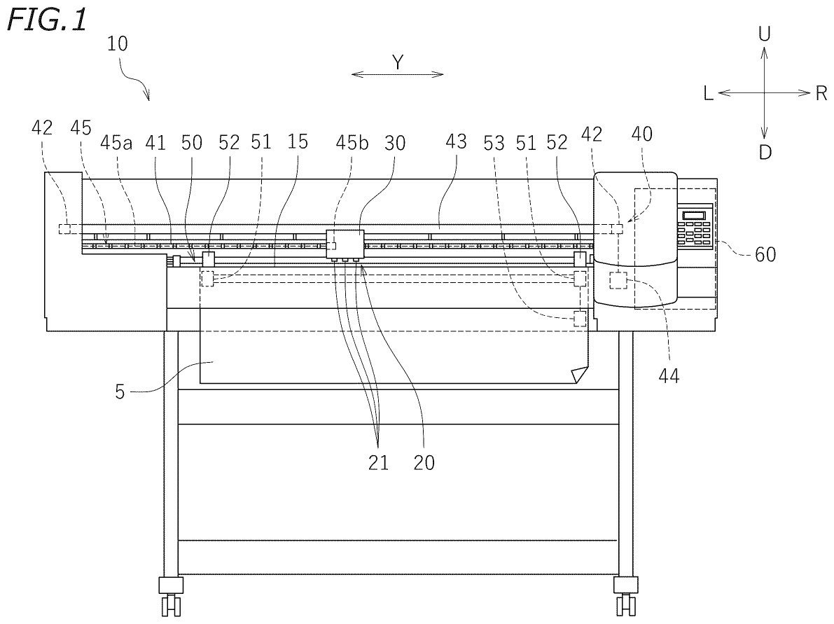

FIG. 1 is a front view of a printer 10 according to this example embodiment. In the following description, the terms “left”, “right”, “up” and “down” respectively refer to left, right, up and down as seen from an operator facing a front side of the printer 10. In a state where the operator faces the front side of the printer 10, a direction from a rear side of the printer toward the operator is defined as a “forward direction”, and a direction from the operator toward the rear side of the printer 10 is defined as a “rearward direction”. In the drawings, letters L, R, U and D respectively refer to left, right, up and down.

The printer 10 performs printing on a recording medium 5 while moving the recording medium 5 in a sub scanning direction. In this example embodiment, the sub scanning direction is a front-rear direction. The printer 10 causes a print head 20 to discharge ink while moving the print head 20 in a main scanning direction Y perpendicular to the sub scanning direction. In this example embodiment, the main scanning direction Y is a left-right direction. In this example embodiment, the main scanning direction X, the sub scanning direction and an up-down direction are perpendicular to each other. Note that the above-described directions are defined merely for the convenience of description, and do not limit the manner of installation or the like of the printer 10 in any way.

The recording medium 5 is, for example, a recording paper sheet. Note that the recording medium 5 is not limited to a recording paper sheet. The recording medium 5 may be formed of paper such as plain paper, inkjet printing paper or the like, a resin material such as polyvinylchloride (PVC), polyester or the like, a metal plate of aluminum, iron or the like, a glass plate, a wooden plate, a cardboard material or the like.

As shown in FIG. 1, the printer 10 includes a platen 15, the print head 20, a carriage 30 having the print head 20 mounted therein and moving in the main scanning direction Y, a carriage moving device 40 to cause the carriage 30 to move in the main scanning direction Y, a transportation device 50 to transport the recording medium 5 in the sub scanning direction, and a controller 60.

The platen 15 is a support table to support the recording medium 5. The platen 15 extends in the main scanning direction Y and the sub scanning direction. The carriage 30 is provided above the platen 15. The print head 20 is provided on the carriage 30. The print head 20 includes a plurality of ink heads 21. The plurality of ink heads 21 each extend in the sub scanning direction. The plurality of ink heads 21 are arranged in the main scanning direction Y. The plurality of ink heads 21 may be located such that positions thereof are aligned in the sub scanning direction, or may be located such that positions of a part of, or all of, the ink heads 21 are shifted in the sub scanning direction in a so-called staggered arrangement. There is no specific limitation on the number or the positional arrangement of the ink heads 21.

Each of the ink heads 21 includes a plurality of nozzles provided therein (not shown) from which ink is discharged. The plurality of nozzles are arranged in the sub scanning direction. The ink is discharged downward from the nozzles, and lands on the recording medium 5 on the platen 15. Each ink head 21 includes, for example, a plurality of piezoelectric elements. Each ink head 21 discharges ink by the piezoelectric elements vibrating upon receipt of a driving signal transmitted from the controller 60. Note that an actuator included in the ink head 21 is not limited to such a piezoelectric element. The ink head 21 may be of, for example, any of various continuous methods including a binary deflection method and a continuous deflection method, or of any of on-demand methods including a thermal method.

There is no specific limitation on the ink discharged from the print head 20. The ink discharged from the print head 20 may be, for example, solvent-based pigment ink, aqueous ink, photocurable ink (e.g., ultraviolet-curable ink, which is cured when receiving ultraviolet rays; so-called UV ink), or the like.

The carriage moving device 40 moves the carriage 30 in the main scanning direction Y. As shown in FIG. 1, the carriage moving device 40 includes a guide rail 41, left and right pulleys 42, an endless belt 43, and a carriage motor 44. The guide rail 41 is located above the platen 15. The guide rail 41 extends in the main scanning direction Y. The carriage 30 is configured to be movable in the main scanning direction Y along the guide rail 41. The carriage 30 is secured to the belt 43. The belt 43 is wound along the left and right pulleys 42. The carriage motor 44 is connected with one of the pulleys 42 and causes the carriage 30 to move. The carriage motor 41 is driven to rotate one of the pulleys 42, so that the belt 43 moves. As a result, the carriage 30 moves in the main scanning direction Y. The print head 20 moves in the main scanning direction Y together with the carriage 30.

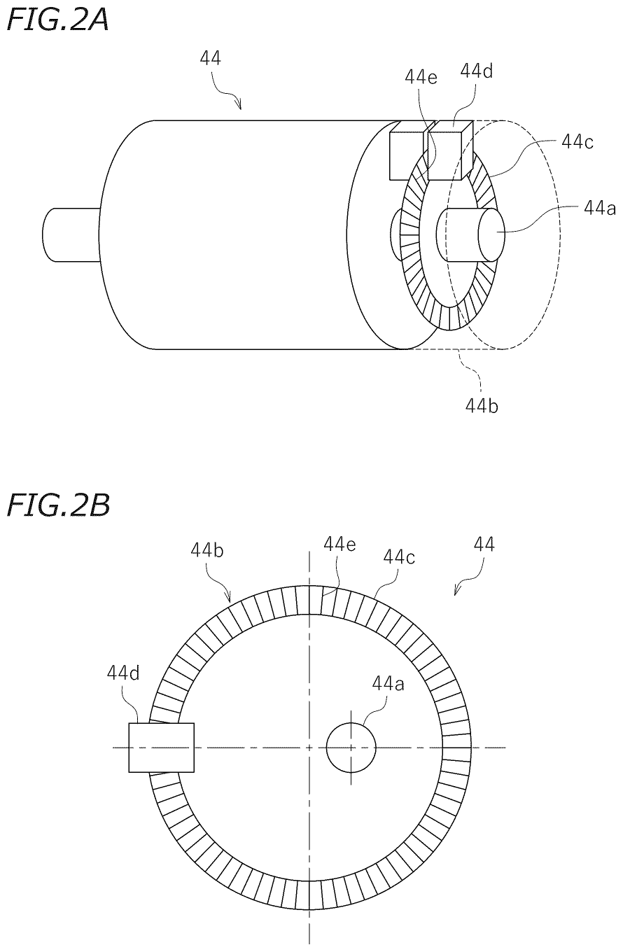

FIG. 2A is a schematic view showing a configuration of the carriage motor 44. FIG. 2B is a view showing a portion, of the carriage motor 44, that is involved in rotation control. As shown in FIGS. 2A and 2B, the carriage motor 44 includes a motor shaft 44a, and a motor encoder 44b to measure a rotation position of the motor shaft 44a. The carriage motor 44 is capable of rotating at a rotation speed thereof controlled based on the rotation position of the motor shaft 44a that is measured by the motor encoder 44b. The motor shaft 44a is connected with one of the pulleys 42 directly or indirectly. The motor encoder 44b includes a disc 44c rotatable together with the motor shaft 44a, and a sensor 44d secured to a motor outer shell (or stator). The disc 44c has many marks 44e formed by, for example, printing, arranged along a circumferential direction. The sensor 44d is configured to sense a mark 44e of the disc 44c. The sensor 44d may sense a mark by an optical method, a magnetic method or any other method. The motor encoder 44b senses a mark 44e rotating together with the motor shaft 44a to measure the rotation position of the motor shaft 44a. The motor encoder 44b is preferably of an absolute type, which measures an absolute position from a rotation origin. Note that in the case where the rotation origin is sensed by any other method, the motor encoder 44b may be of an increment type, which senses a relative position from any rotation position. In this example embodiment, the motor encoder 44b outputs a pulse signal each time when the sensor 44d senses a mark 44e.

In this example embodiment, the printer 10 includes a linear encoder 45 capable of measuring a position of the carriage 30 in the main scanning direction Y. As shown in FIG. 1, the linear encoder 45 includes a scale 45a and a head 45b. The scale 45a has many marks (not shown) arranged in the main scanning direction Y. The scale 45a is, for example, secured to the guide rail 41. The head 45b is, for example, secured to the carriage 30. The head 45b is configured to sense the marks of the scale 45a. The head 45b may sense the marks by an optical method, a magnetic method or any other method. The linear encoder 45 senses the marks with the head 45b, moving together with the carriage 40, to measure the position of the carriage 30 in the main scanning direction Y. The position of the carriage 30 is measured based on the number of the marks sensed.

The transportation device 50 moves the recording medium 5 in the sub scanning direction. As shown in FIG. 1, the transportation device 50 includes grit rollers 51, pinch rollers 52, and a feed motor 53. The grit rollers 51 are buried in the platen 15. Each of the grit rollers 51 is partially exposed on the platen 15. The feed motor 53 rotates the grit rollers 51 in the sub scanning direction. The pinch rollers 52 press the recording medium 5 from above. The pinch rollers 52 are located above the grit rollers 51. The pinch rollers 52 are provided at positions facing the grit rollers 51. The pinch rollers 52 are configured to be movable in the up-down direction. When, in a state where the recording medium 5 is sandwiched between the grit rollers 51 and the pinch rollers 52, the feed motor 53 is driven to rotate the grit rollers 51, the recording medium 5 is transported in the sub scanning direction.

The controller 60 is electrically connected to each of the plurality of ink heads 21, the carriage motor 44 of the carriage moving device 40, and the feed motor 53 of the transportation device 50, and is configured or programmed to control operations thereof. The controller 60 is electrically connected with the linear encoder 45, and receives a signal from the linear encoder 45. There is no specific limitation on the configuration of the controller 60. The controller 60 is, for example, a microcomputer. There is no specific limitation on the hardware configuration of the microcomputer. For example, the microcomputer includes an interface (I/F) receiving printing data or the like from an external device such as a host computer or the like, a central processing unit (CPU) executing instructions of a control program, a ROM (read only memory) storing a program to be executed by the CPU, a RAM (random access memory) to be used as a working area in which the program is developed, and a storage device, such as a memory or the like, storing the above-described program or various types of data. Note that the controller 60 does not need to be provided inside the printer 10, and may be, for example, a computer or the like installed outer to the printer 10 and communicably connected with the printer 10 in a wired or wireless manner.

Hereinafter, a method for correcting a speed of the carriage 30 will be described. According to the method described below, a change in the rotation speed of the motor shaft 44a during one rotation thereof is decreased, so that the change in the speed of the carriage 30 is decreased. With the method according to this example embodiment, a correction value is added to the rotation position of the motor shaft 44a measured by the motor encoder 44b so as to decrease the change in the rotation speed of the motor shaft 44a during one rotation thereof.

First, a reason why the rotation speed of the carriage motor 44 is changed during one rotation thereof will be described. As schematically shown in FIG. 2B, there may be a case where slight but non-negligible eccentricity is present between the motor shaft 44a and the disc 44c. As shown in FIG. 2B, when the disc 44c rotates together with the motor shaft 44a in a state where the disc 44c is eccentric with respect to the motor shaft 44a, the marks 44e approach, or are distanced from, the sensor 44d in accordance with the rotation position of the disc 44c. In the example of FIGS. 2A and 2B, the marks 44e approach, or are distanced from, the sensor 44d in the left-right direction in the figure. Therefore, when the motor shaft 44a and the disc 44c rotate at a constant speed, the rotation speed of the motor shaft 44a measured by the motor encoder 44b is increased or decreased. The carriage motor 44 is configured to rotate at the rotation speed thereof controlled based on the rotation position of the motor shaft 44a measured by the motor encoder 44b. Therefore, in the case where the rotation speed of the motor shaft 44a is controlled to be constant based on the rotation position thereof measured by the motor encoder 44b, the rotation speed of the motor shaft 44a is actually changed during one rotation thereof.

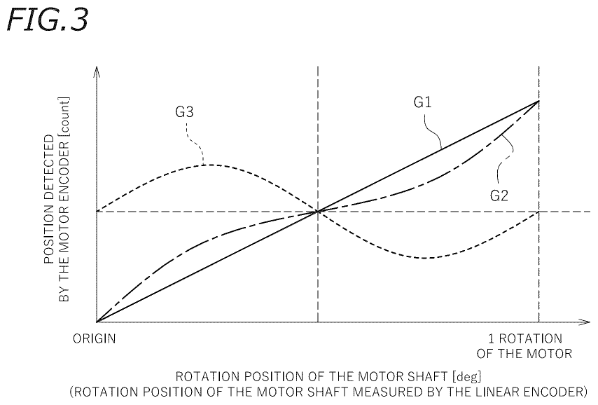

FIG. 3 is a graph showing a shift in the position detection of the motor shaft 44a caused by the eccentricity. The horizontal axis of FIG. 3 represents the actual rotation position (unit: angle) of the motor shaft 44a. Each of values on the horizontal axis is based on the position of the carriage 30 measured by the linear encoder 45. The position of the carriage 30 measured by the linear encoder 45 reflects the actual rotation position of the motor shaft 44a. The vertical axis of FIG. 3 represents the rotation position of the motor shaft 44a measured by the motor encoder 44b (unit: count number of pulses that are output by the motor encoder 44b).

In FIG. 3, a line G1 represents the rotation position of the motor shaft 44a measured by the motor encoder 44b with respect to the rotation position of the motor shaft 44a measured by the linear encoder 45 (hereinafter, referred to also as the “actual rotation position of the motor shaft 44a) in the case where there is no eccentricity in the carriage motor 44. As shown in FIG. 3, the line G1 is a straight line. A line G2 represents the rotation position of the motor shaft 44a measured by the motor encoder 44b with respect to the actual rotation position of the motor shaft 44a in the case where there is eccentricity in the carriage motor 44. As shown in FIG. 3, the line G2 is a curved line that crosses the line G1 at two points that are away from each other by 180 degrees, and is above the line G1 on one side with respect to the intersection and is below the line G1 on the other side with respect to the intersection.

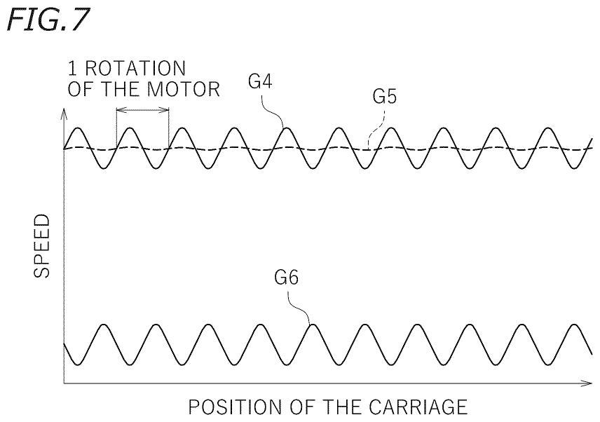

Referring to the graph in FIG. 7, in the case where the carriage motor 44 having such characteristics is controlled to rotate at a constant speed, the speed of the carriage 30 draws sine curves as represented by a line G4 (line representing a pre-correction state). The horizontal axis of FIG. 7 represents the commanded position of the carriage 30. The vertical axis of FIG. 7 represents the speed of the carriage 30 based on the measurement performed by the linear encoder 45. One cycle of the sine curves corresponds to one rotation of the motor shaft 44a.

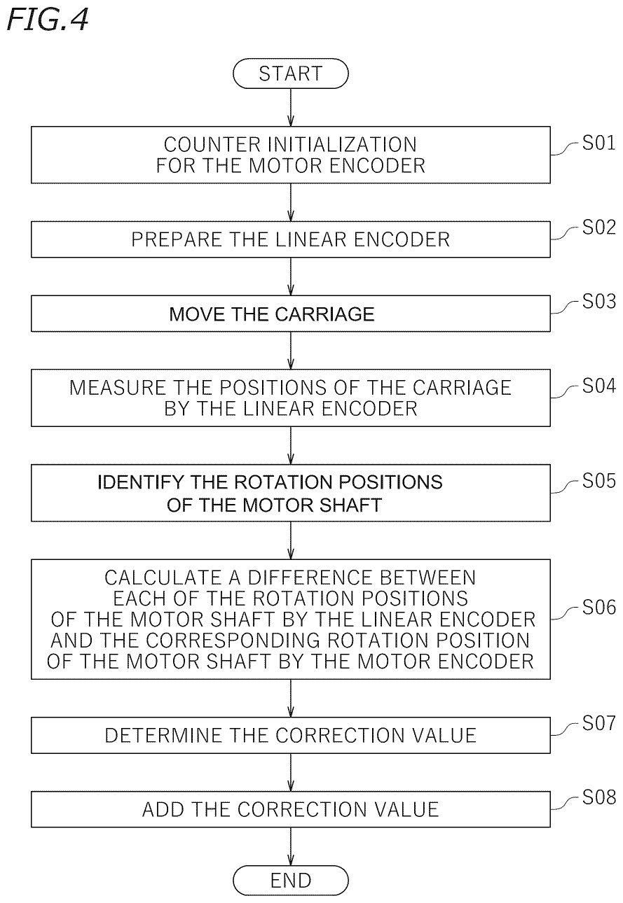

FIG. 4 is a flowchart showing a procedure for correcting the rotation speed of the carriage motor 44. As shown in FIG. 4, steps for correcting the rotation speed of the carriage motor 44 according to this example embodiment include counter initialization step S01 for the motor encoder 44b, preparation step S02 for the linear encoder 45, moving step S03 of causing the carriage 30 to move at a constant speed, measurement step S04 of measuring a plurality of the positions of the carriage 30 in the main scanning direction Y by the linear encoder 45, first calculation step S05 of identifying rotation positions of the motor shaft 44a, second calculation step S06 of calculating a difference between each of a plurality of the rotation positions of the motor shaft 44a based on the measurement performed by the motor encoder 44b and an actual rotation position of the motor shaft 44a corresponding to the rotation position thereof based on the measurement performed by the motor encoder 44b, determination step S07 of determining a correction value to be added to the rotation positions of the motor shaft 44a measured by the motor encoder 44b, and correction step S08 of adding the correction value to the rotation positions of the motor shaft 44a measured by the motor encoder 44b.

In the counter initialization step S01 for the motor encoder 44b, a counter value of the motor encoder 44b is set to zero. The counter value of the motor encoder 44b initialized to zero is used as the reference point at a time of phase offset measurement and at a time of correction in the subsequent steps.

In the preparation step S02, a linear encoder capable of measuring the position of the carriage 30 in the main scanning direction Y is prepared. The printer 10 according to this example embodiment includes the linear encoder 45. Therefore, the preparation step S02 is included in the process of producing the printer 10. In the case where the printer does not include a linear encoder, a linear encoder may be temporarily attached to the printer.

In the moving step S03, the carriage motor 44 is rotated such that the rotation speed thereof based on the measurement performed by the motor encoder 44b is constant, and the carriage 30 is caused to move. In other words, constant speed control on the carriage motor 44 is performed by a usual method. In the moving step S03, the rotation speed of the carriage motor 44 is set to be significantly low. The rotation speed of the carriage motor 44 is set to be significantly low, so that the measurement resolutions of the motor encoder 44b and the linear encoder 45 are increased and thus highly precise correction is made possible. It is preferred that the rotation speed of the carriage motor 44 in the moving step S03 is lower than at least the rotation speed of the carriage motor 44 at the time of printing. The rotation speed of the carriage motor 44 in the moving step S03 is preferably about 60 rpm, for example. The speed of the carriage 30 in the moving step S03 is preferably about 20 mm/second, for example.

In the measurement step S04, the plurality of positions of the carriage 30 in the main scanning direction Y in the moving step S03 are measured by the linear encoder 45. As a result, data to specify the actual rotation positions of the motor shaft 44a is acquired. In the first calculation step S05, the rotation positions of the motor shaft 44a in the moving step S03 (actual rotation positions) are identified based on the measurement performed by the linear encoder 45.

In the second calculation step S06, a difference between each of the rotation positions of the motor shaft 44a based on the measurement performed by the motor encoder 44b and the corresponding rotation position of the motor shaft 44a based on the measurement performed by the linear encoder 45 is calculated for a plurality of rotation positions of the motor shaft 44a during one rotation or a plurality of rotations thereof. In FIG. 3, a line G3 represents the difference calculated in the second calculation step S06 (note that for the sake of easier understanding, the line G3 is expanded in the vertical direction by making the scale of the line G3 smaller than those of lines G1 and G2 along the vertical axis, and the center of the vertical axis is set as point zero). As shown in FIG. 3, the line G3 draws a sine curve. In the example of FIG. 3, the eccentricity error at the origin of the horizontal axis corresponds to zero of the sine curve. However, this may be shifted depending on the angle of the motor shaft 44a at a time of assembly.

In the determination step S07, a correction value to be added to the rotation positions of the motor shaft 44a measured by the motor encoder 44b is determined based on the differences calculated in the second calculation step S06, such that the change in the rotation speed of the motor shaft 44a, during one rotation thereof, based on the measurement performed by the linear encoder 45 (actual rotation speed) is decreased. In this example embodiment, the correction value includes a correction value for the amplitude (gain) of the sine curve and a correction value for the phase difference between the zero position of the sine curve and the origin. In the correction step S08, the correction value determined in the step S07 is added to the rotation positions of the motor shaft 44a measured by the motor encoder 44b. In more detail, for example, the correction value is stored on the controller 60, and the rotation position of the motor shaft 44a measured by the motor encoder 44b and fed back is corrected each time when the position is fed back. In this manner, the change in the actual rotation speed of the carriage motor 44 during one rotation is decreased. That is, the speed of the carriage 30, which has been increased or decreased so as to draw a sine curve in accordance with the position of the carriage 30, is made closer to a constant speed. Hereinafter, such a process will be referred to also as an “eccentricity correction process”. Note that the calculation of the correction value performed in steps S01 through S08 is performed at a time of production or the maintenance of the printer 10 in this example embodiment. Alternatively, the calculation may be performed at a time of printing.

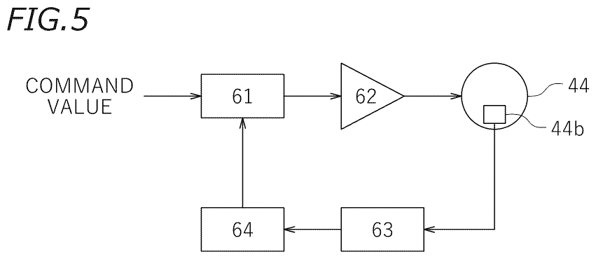

FIG. 5 is a block diagram showing the rotation control, on the carriage motor 44, including the eccentricity correction process. As shown in FIG. 5, in the rotation control on the carriage motor 44 according to this example embodiment, a command value on the rotation speed is input to a control processor 61 of the controller 60, and feedback control to realize the rotation speed as commanded by the command value is circulated. An output signal that is output by the control processor 61 is received by a motor driver 62. The motor driver 62 controls the rotation of the carriage motor 44 based on the received signal. For example, the motor driver 62 adjusts an electric current to flow to the carriage motor 44. The motor encoder 44b of the carriage motor 44 outputs a pulse signal each time when, for example, a mark 44e is detected. The pulse signal is received by a counter 63. The value of the counter 63 is corrected by a corrector 64. The output of the counter 63 after the value thereof is corrected by the corrector 64 is fed back to the control processor 61.

The correction value includes a phase offset amount defined based on the rotation positions of the motor shaft 44a at a time when differences between the rotation positions of the motor shaft 44a measured by the motor encoder 44b and the actual rotation positions of the motor shaft 44a are generated, and also includes a gain defined based on the amount of the differences. The phase offset value depends on the direction of the eccentricity in the carriage motor 44. The amplitude depends on the magnitude of the eccentricity in the carriage motor 44.

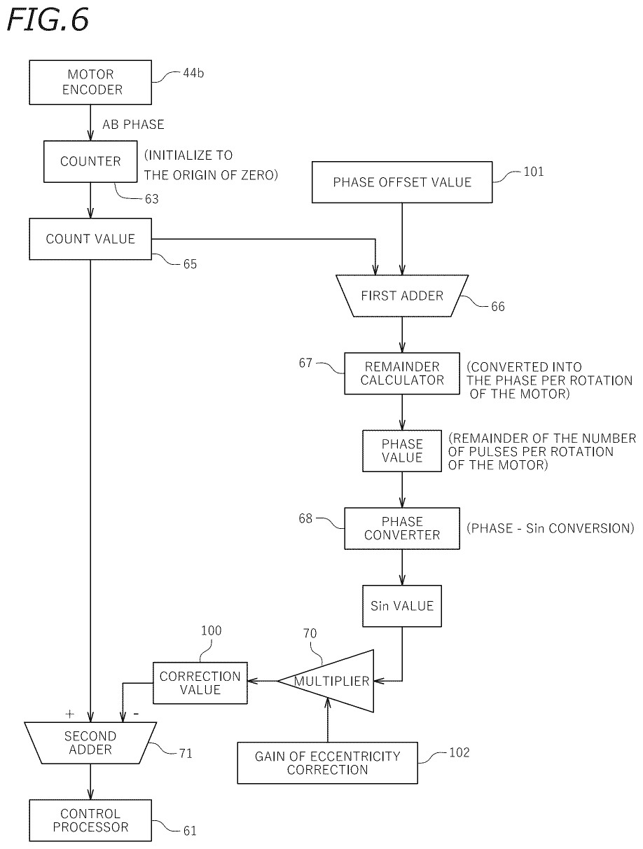

FIG. 6 is a block diagram showing the procedure of the eccentricity correction process. As shown in FIG. 6, in the eccentricity correction process, the pulse signal that is output from the motor encoder 44b is counted by the counter 63. A count value 65 of the counter 63 is assumed to be initialized in advance by an origin detection function at a time of start of the printer 10. The count value 65 is input to a first adder 66, and a phase offset value 101, which is defined in advance by the procedure shown in FIG. 4, is added to the count value 65. The output of the first adder 66 is input to a remainder calculator 67. The remainder calculator 67 calculates a remainder obtained as a result of the input number of pulses being divided by the number of pulses during one rotation of the motor shaft 44a (the remainder corresponds to the offset rotation position of the motor shaft 44a). A phase converter 68 converts the remainder calculated by the remainder calculator 67 into a sine value. A multiplier 70 multiplies the value, obtained as a result of the conversion performed by the phase converter 68, by a gain value 102 calculated by the procedure shown in FIG. 4, to calculate a correction value 100. A second adder 71 performs a calculation of subtracting the correction value 100 from the count value 65 of the motor encoder 44b, and the resultant value is used as the output of the second adder 71. The output of the second adder 71 is fed back to the control processor 61.

FIG. 7 is a graph showing a comparison of a pre-correction speed of the carriage 30 and a post-correction speed of the speed of the carriage 30. In FIG. 7, the line G4 represents the pre-correction speed of the carriage 30. A line G5 represents the post-correction speed of the carriage 30. A line G6 represents the correction value. As described above, the horizontal axis of FIG. 7 represents the commanded position of the carriage 30. The vertical axis of FIG. 7 represents the speed of the carriage 30 based on the measurement performed by the linear encoder 45. As shown in FIG. 7, in the printer 10 after the speed of the carriage motor 44 is corrected, the change in the speed of the carriage 30 is smaller than in the printer 10 before the speed of the carriage motor 44 is corrected. A range where the line G5 is present along the vertical axis is smaller than a range where the line G4 is present along the vertical axis. Thus, the method according to this example embodiment reduces or prevents changes in the speed of the carriage 30 caused depending on the position thereof in the main scanning direction Y.

Hereinafter, the method for calculating the phase difference and the gain in the second calculation step S08 will be described in detail.

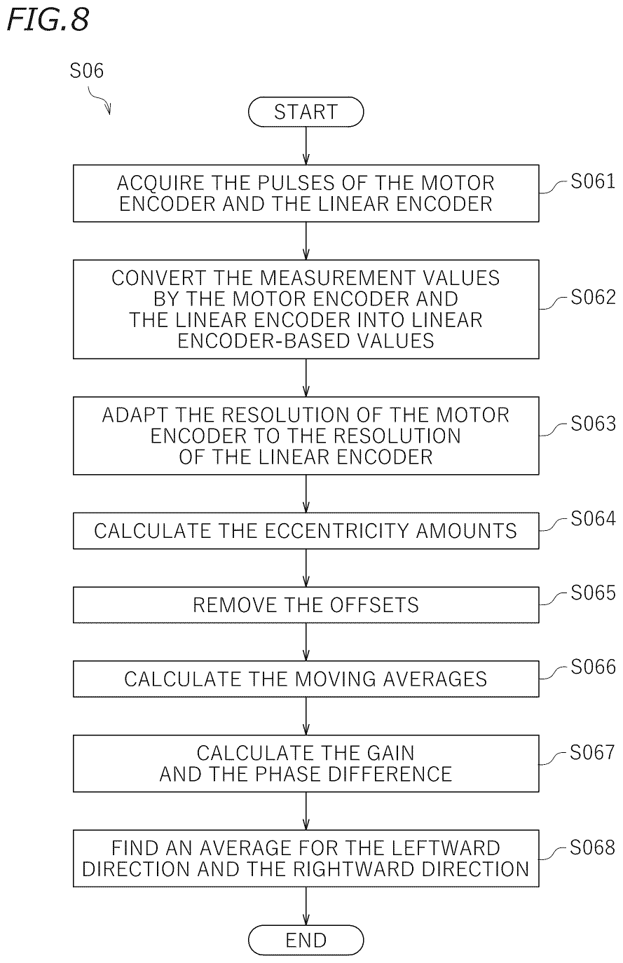

FIG. 8 is a flowchart showing details of the second calculation step S06. As shown in FIG. 8, in step S061 of the second calculation step S06, pulses sent out by the motor encoder 44b and the linear encoder 45 are acquired. The pulses of the motor encoder 44b and the pulses of the linear encoder 45 are sampled at the same time and at a constant cycle. In this example embodiment, the pulses of the motor encoder 44b and the linear encoder 45 are sampled for a plurality of rotations of the motor shaft 44a, for example, for 10 rotations. This raises the precision of the phase difference and the gain acquired. Note that there is no specific limitation on the number of times of sampling, the sampling cycle or the sampling period of the pulses of the motor encoder 44b or the linear encoder 45.

In step S062, the measurement values of the motor encoder 44b and the linear encoder 45 (the measurement values each represent the rotation positions of the motor shaft 44a) acquired in step S061 are converted from the values based on time into values based on the linear encoder 45. In more detail, a measurement value of the motor encoder 44b at a timing when each measurement value of the linear encoder 45 is changed is acquired, so that a position of the motor shaft 44a based on the measurement performed by the motor encoder 44b with respect to each position of the motor shaft 44a based on the measurement performed by the linear encoder 45 is acquired.

In step S063, the resolution of the measurement values of the motor encoder 44b are adapted to the resolution of the measurement values of the linear encoder 45. In more detail, in the case where the resolution of the motor encoder 44b is lower than the resolution of the linear encoder 45, the measurement values of the motor encoder 44b are linearly interpolated. In the case where the resolution of the motor encoder 44b is higher than the resolution of the linear encoder 45, step S063 is not necessary.

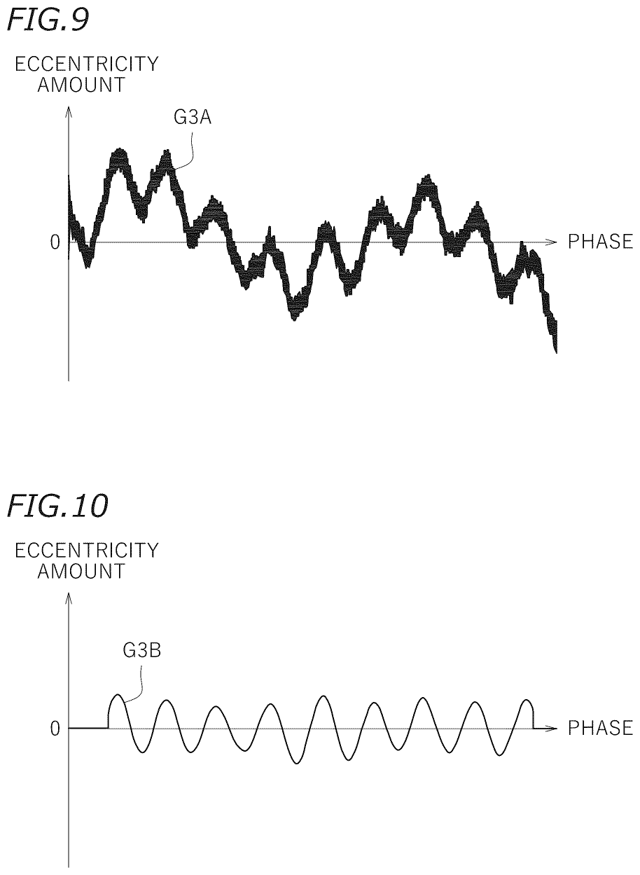

In step S064, a deviation of a measurement value of the motor encoder 44b with respect to a measurement value of the linear encoder 45 (hereinafter, referred to as an “eccentricity amount”) is calculated at each of sampling points of data by the linear encoder 45. FIG. 9 is a graph showing the eccentricity amount of the carriage motor 44. The horizontal axis of FIG. 9 represents the sampling point by the linear encoder 45. The vertical axis of FIG. 9 represents the eccentricity amount. As shown in FIG. 9, as a result of step S064, a line G3A, which is a sine curve including an offset (noise), is obtained as a line representing the eccentricity amount.

In step S065, the offset (noise in the vertical axis direction in FIG. 9) included in the eccentricity amount is removed. In more detail, for each of all of the sampling points represented by the horizontal axis of FIG. 9, an eccentricity amount of a point prior to such a sampling point by phase π/2 and an eccentricity amount of a point subsequent to such a sampling point by phase π/2 (where the phase of a certain sampling point is θ, a point at phase (θ-π/2) and a point at phase (θ+π/2)) are acquired, and an average of these eccentricity amounts is subtracted from the eccentricity amount at the certain sampling point. As a result, the offset in the vertical axis direction of FIG. 9 is removed.

Furthermore in step S066, for each of all of the sampling points represented by the horizontal axis of FIG. 9, a moving average is calculated to decrease the noise. In this example embodiment, a moving average in a range of about ¼ of one cycle, that is, a range of an angle of about π/2, is calculated, for example. FIG. 10 is a graph showing the eccentricity amount after the noise is removed. As shown in FIG. 10, as a result of the noise removal process in steps S065 and S066, the line representing the eccentric amount becomes a line G3B, which is generally a sine curve.

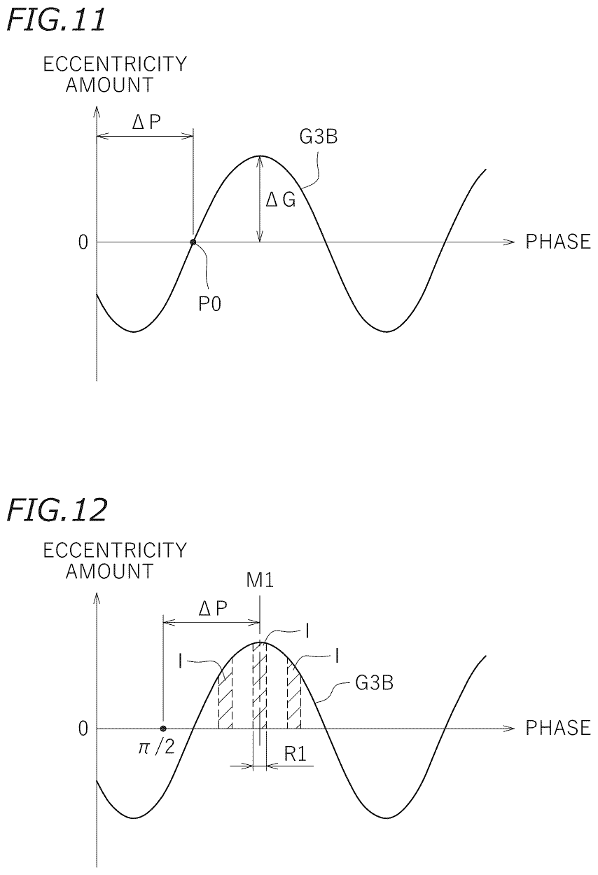

In step S067, the gain and the phase difference are calculated. In step S067, data in a constant speed period, in which the carriage motor 30 rotates at a constant speed, is used. Data in a period in which the carriage motor 30 is accelerated or decelerated is not used. FIG. 11 is a graph showing a phase difference ΔP and a gain ΔG of the line G3B representing the eccentricity amount after the noise is removed. As shown in FIG. 11, the maximum eccentric amount in the period, the data of which is used, is adopted as the gain ΔG. Alternatively, an absolute value of a local maximum and an absolute value of a local minimum of the eccentricity amount in the period, the data of which is used, may be calculated, and an average of these absolute values may be used as the gain ΔG.

As shown in FIG. 11, as the phase difference ΔP, a phase of point P0 (value on the horizontal axis), at which the line G3B representing the eccentricity amount shows a deviation of zero (the value on the vertical axis is zero) for the first time is adopted. Hereinafter, a point at which the line G3B representing the eccentric amount crosses the line having a deviation of zero (horizontal axis) for the first time will be referred to also as “zero cross point P0”. The phase difference ΔP is a phase difference between the origin of the linear encoder 45 and the zero cross point P0. At the zero cross point P0, the differential (change ratio) of the eccentricity amount is largest. At the zero cross point P0, the gradient of the line G3B is largest. The zero cross point P0 is actually a phase between a sampling point at which the eccentricity amount is slightly larger than zero and a sampling point at which the eccentricity amount is slightly smaller than zero. Therefore, the phase difference ΔP has a high precision when being calculated at a point at which the differential of the eccentricity amount is large. In step S067, a plurality of phase differences ΔP are calculated in the period, and an average of these phase differences ΔP is calculated to determine the phase difference.

In step S068, an average of the phase difference calculated by moving the carriage 30 leftward and the phase difference calculated by moving the carriage 30 rightward is calculated. There may be a case where the moving speed of the carriage 30 is different between when the carriage 30 is moved leftward and when the carriage 30 is moved rightward by, for example, a difference in a mechanical condition such an elongation of the belt 43. Therefore, in step S068, an average of the phase difference calculated by moving the carriage 30 leftward and the phase difference calculated by moving the carriage 30 rightward is calculated.

Note that the above-described second calculation step S06 is merely an example embodiment, and the second calculation step S06 is not limited to this.

For example, in an example embodiment, the eccentricity amounts of a predetermined number of sampling points are integrated (the size of an area below or above a range having a predetermined width on the horizontal axis is calculated), and a middle point M1 of the range of a period R1, in which an integral I is maximum, is calculated (see FIG. 12). In the example of FIG. 12, the eccentricity amount of the period R1 has a positive value. The phase of the middle point M1 of the period R1 is about π/2, for example, assuming that there is no phase difference in the eccentricity amount. Therefore, the phase difference between the middle point M1 and a point of phase of about π/2 may be calculated as the phase difference ΔP, for example. Note that in the case where the eccentricity amount of the period R1 has a negative value, the phase difference ΔP between the middle point M1 and a point of phase of about 3π/2 may be calculated, for example.

In another example embodiment, for example, the point at which the differential (change ratio) of the eccentricity amount is largest may be regarded as the zero cross point P0.

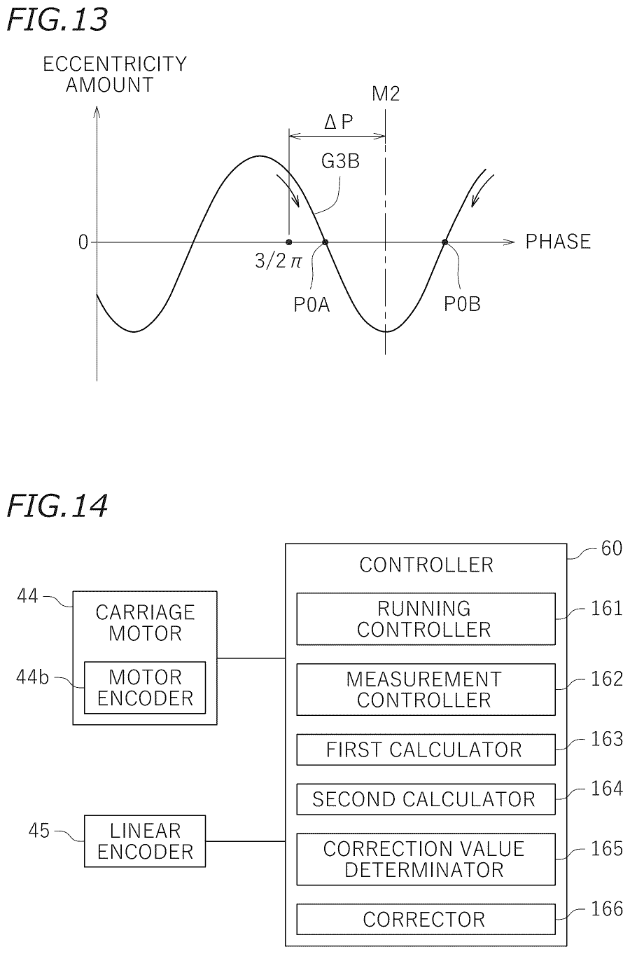

In still another example embodiment, two zero cross points P0A and P0B adjacent to each other, at which the respective eccentricity amounts are each changed from a positive value to a negative value, are identified (in this example embodiment, the zero cross point refers to each of points at which the line G3B representing the eccentricity amount crosses the line having a deviation of zero (horizontal axis)). Assuming that there is no phase difference in the eccentricity amount, the phase of a middle point M2 between the two zero cross points P0A and P0B is a point of about 3π/2 (see FIG. 13), for example. In this case, the phase difference ΔP is a phase difference between the middle point M2 and a point of phase of about 3π/2, for example. Note that the two zero cross points may be two zero cross points adjacent to each other at which the respective eccentricity amounts are each changed from a negative value to a positive value.

According to still another example embodiment, the phase of one zero cross point P0 is identified from a direction in which the eccentricity amount is changed from a positive value to a negative value and from a direction in which the eccentricity amount is changed from a negative value to a positive value. As a result, the precision of the phase of the zero cross point P0 is raised.

In still another example embodiment, a local maximum point of the line G3B representing the eccentricity amount (a point at which the gradient changes from a positive value to a negative value and at which the gradient is zero) or a local minimum point of the line G3B representing the eccentricity amount (a point at which the gradient changes from a negative value to a positive value and at which the gradient is zero) is adopted. In this example embodiment, assuming that there is no phase difference in the eccentricity amount, the phase of the local maximum point is about π/2, and the phase of the local minimum point is about 3π/2, for example. The phase difference ΔP is a phase difference between the local maximum point and a point of phase of about π/2, or a phase difference between the local minimum point and a point of phase of about 3π/2, for example.

As described above, there are various methods for calculating the phase difference between the phase of the motor shaft 44a based on the measurement performed by the motor encoder 44b and the phase of the motor shaft 44a based on the measurement performed by the linear encoder 45. There is no specific limitation on such a method. Similarly, the method for calculating the gain is not limited to the above-described method.

Example embodiments of the present invention are described above. Nonetheless, the above-described example embodiments are merely illustrative examples, and the present invention may be carried out in any of various other example embodiments. For example, in the above-described example embodiments, the correction of the rotation speed of the carriage motor 44 is not necessarily performed by the printer 10. The correction of the rotation speed of the carriage motor 44 may be automatically performed by the printer 10. In this case, the printer 10 includes the print head 20, the carriage 30 having the print head 20 mounted thereon and moving in the main scanning direction Y, the carriage motor 44 to cause the carriage 30 to move, the linear encoder 45 to measure the position of the carriage 30 in the main scanning direction Y, and the controller 60. The carriage motor 44 is a motor that includes the motor shaft 44a and the motor encoder 44b to measure the rotation position of the motor shaft 44a, and is capable of rotating at the rotation speed thereof controlled based on the rotation position of the motor shaft 44a measured by the motor encoder 44b.

FIG. 14 is a block diagram of such a printer 10. As shown in FIG. 14, in this example embodiment, the controller 60 is configured or programmed to include a moving controller 161, a measurement controller 162, a first calculator 163, a second calculator 164, a correction value determinator 165, and a corrector 166. The moving controller 161 rotates the carriage motor 44 such that the rotation speed thereof based on the measurement performed by the motor encoder 44b is constant, and causes the carriage 30 to move. The measurement controller 162 measures the rotation positions of the carriage 30 in the main scanning direction Y by use of the linear encoder 45 while the carriage 30 is moving under the control of the moving controller 161. The first calculator 163 identifies the rotation positions of the motor shaft 44a (see FIG. 2A) during the moving of the carriage 30, based on the measurement performed by the linear encoder 45. The second calculator 164 calculates a difference between each of the rotation positions of the motor shaft 44a based on the measurement performed by the motor encoder 44b and the corresponding rotation position of the motor shaft 44a identified by the first calculator 163, regarding a plurality of rotation positions during one rotation or a plurality of rotations of the motor shaft 44a. The correction value determinator 165 determines a correction value to be added to the rotation positions of the motor shaft 44a measured by the motor encoder 44b, based on the differences calculated by the second calculator 164, such that the change in the rotation speed of the motor shaft 44a, during one rotation thereof, based on the measurement performed by the linear encoder 45 is decreased. The corrector 166 adds the correction value to the rotation positions of the motor shaft 44a measured by the motor encoder 44b.

According to the printer 10 having such a configuration, like in the above-described example embodiments, the change in the speed of the carriage 30 caused by the change in the rotation speed of the carriage motor 44 during one rotation thereof is decreased.

In the above-described example embodiments, the printer 10 is of a type in which the recording medium 5 is transported on the platen 15. There is no specific limitation on the type of the printer. The printer may be a so-called flat bed-type printer including a flat bed movable while having the recording medium 5 placed thereon.

The circuit, the device or the process that adds a correction value described with reference to FIG. 6 in the above-described example embodiment, in other words, the method for realizing the correction step S08, is merely an example embodiment. The process of adding a correction value to the rotation position of the motor shaft measured by the motor encoder is not limited to the above-described process.

The example embodiments described above do not limit the present invention unless otherwise specified.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for correcting a speed of a carriage in a printer including a print head, the carriage having the print head mounted thereon and movable in a predetermined scanning direction, and a motor causing the carriage to move, the motor including a motor shaft and a motor encoder measuring a rotation position of the motor shaft, the motor is capable of rotating at a rotation speed thereof controlled based on the rotation position of the motor shaft measured by the motor encoder, the method comprising:
a preparation step of preparing a linear encoder capable of measuring positions of the carriage in the scanning direction;
a moving step of rotating the motor such that the rotation speed thereof based on the measurement performed by the motor encoder is constant, and causing the carriage to move;
a measurement step of measuring a plurality of the positions of the carriage in the scanning direction in the moving step by use of the linear encoder;
a first calculation step of identifying rotation positions of the motor shaft in the moving step based on the measurement performed by the linear encoder;
a second calculation step of calculating a difference between each of a plurality of the rotation positions of the motor shaft based on the measurement performed by the motor encoder and the corresponding rotation position of the motor shaft based on the measurement performed by the linear encoder, for a plurality of rotation positions during one rotation or a plurality of rotations of the motor shaft;
a determination step of determining a correction value to be added to the rotation positions of the motor shaft measured by the motor encoder, based on the differences calculated in the second calculation step, such that a change in the rotation speed of the motor shaft, during one rotation thereof, based on the measurement performed by the linear encoder is decreased; and
a correction step of adding the correction value to the rotation positions of the motor shaft measured by the motor encoder.

2. The method according to claim 1, wherein the correction value includes a phase offset value defined based on the rotation position of the motor shaft when the differences are generated, and a gain defined based on an amount of the differences.

3. The method according to claim 1, wherein the rotation speed of the motor in the moving step is lower than the rotation speed of the motor at a time of printing.

4. A printer, comprising:
a print head;
a carriage having the print head mounted thereon and movable in a predetermined scanning direction;
a motor to cause the carriage to move;
a linear encoder to measure a position of the carriage in the scanning direction; and
a controller; wherein
the motor includes a motor shaft and a motor encoder to measure a rotation position of the motor shaft, and is capable of rotating at a rotation speed thereof controlled based on the rotation position of the motor shaft measured by the motor encoder; and
the controller is configured or programmed to include:
a moving controller configured or programmed to rotate the motor such that the rotation speed thereof based on the measurement performed by the motor encoder is constant, and to cause the carriage to move;
a measurement controller configured or programmed to measure a plurality of the positions of the carriage in the scanning direction by the linear encoder while the carriage is moving under the control of the moving controller,
a first calculator configured or programmed to identify rotation positions of the motor shaft during the moving of the carriage, based on the measurement performed by the linear encoder;
a second calculator configured or programmed to calculate a difference between each of the rotation positions of the motor shaft based on the measurement performed by the motor encoder and the corresponding rotation position of the motor shaft identified by the first calculator, for a plurality of rotation positions during one rotation or a plurality of rotations of the motor shaft;
a correction value determinator configured or programmed to determine a correction value to be added to the rotation positions of the motor shaft measured by the motor encoder, based on the differences calculated by the second calculator, such that a change in the rotation speed of the motor shaft, during one rotation thereof, based on the measurement performed by the linear encoder is decreased; and
a corrector configured or programmed to add the correction value to the rotation positions of the motor shaft measured by the motor encoder.
